(19) United States
(12) Patent Application Publication
(10) Pub. No.: US 2007/0084672 A1
(43) Pub. Date: Apr. 19, 2007

(54) Self-propelled elevator

(75) Inventors: Theodor Helmle, Ellwangen (DE); Roland Koblinger, Backnang (DE); Klaus Bauer, Buttenhard (DE)

Correspondence Address: BACHMAN & LAPOINTE, P.C., 900 CHAPEL STREET, SUITE 1201, NEW HAVEN, CT, 06510, US

(73) Assignee: Wittenstein AG

(21) Appl. No.: 11/529,121

(22) Filed: Sep. 28, 2006

(30) Foreign Application Priority Data
Oct. 13, 2005 (DE) 102005049408.0-22

(51) Int. Cl. B66B 9/02

(52) U.S. Cl. 187/270

(57) ABSTRACT

In a self-propelled elevator for essentially the transport of persons with a cabin (11) to which at least one drive (14) is assigned, the at least one drive (14) engages with a linear guide (8), directly or indirectly, via at least one drive element (13) for linear driving of the cabin.

### CROSS REFERENCE TO RELATED APPLICATIONS

This case is a U.S. Application which claims priority of German Application No. 10 2005049 408.0 filed Oct. 13, 2005.

### BACKGROUND OF THE INVENTION

The present invention relates to a self-propelled elevator for essentially the transport of persons with a cabin to which at least one drive is assigned.

Such self-propelled elevators are known and available in a wide variety of forms and designs on the market.

These are generally driven by complex systems comprising rope hoists, counterweights, drive machines, etc., so that not only the manufacturing costs but also the operating and maintenance costs are significant.

Furthermore, conventional elevators are expensive to install and take up a great deal of space in the elevator shaft. The elevator cabins are therefore minimized in relation to the size of the shaft that is equally as undesirable.

The object of the present invention is therefore to create a self-propelled elevator that overcomes the disadvantages described above, and with which in a simple and inexpensive manner an elevator can be integrated inexpensively into any shaft taking up the least possible space, that is quick to install, has economically attractive service intervals and is operationally safe.

### SUMMARY OF THE INVENTION

The object is achieved with the present invention by providing a drive to a cabin of a self-propelled elevator, which drive having at least one drive element.

The drive and the drive element can be provided here in the area of the cabin roof and/or cabin floor.

The drive element configured as a drive pinion, roller pinion or similar element is preferably engaged positively with a linear guide, preferably configured as a rack.

The linear guide is firmly supported separably within a travel and/or guide profile or separably fixed there. The travel and/or guide profile serves also for exact guidance of the cabin by means of guide rollers or gauge rollers that are provided in each of the side areas, preferably in the area of the cabin roof and cabin floor in order to align the cabin during the linear movement.

A further feature of the present invention is that the travel and/or guide profile is mounted vibration-damped with respect to a construction and/or wall, preferably via a plurality of fastening elements.

At least one rubber buffer is inserted between each fastening element and the travel and/or guide profile, but it is also conceivable that the rubber buffer itself can be connected to a construction or a wall or similar structure. The invention is not limited to this.

Due to the vibration-damping property of the travel and/or guide profile, the complete cabin with its drive and drive element that engages positively in at least one linear guide has a vibration-damping mounting.

It should be considered that several travel and/or guide profiles arranged alongside one another and/or opposite one another contact the outside of the cabin, bearing and supporting it also against several travel and/or guide profiles.

It should also be considered that a drive with drive element, in particular a drive pinion, that is positively engaged with the linear guide, in particular with a rack, may be provided not only in the cabin roof area, but also if necessary in the area of the cabin floor.

By connecting several drives, generally smaller drives can also be used. This should also lie within the scope of the present invention.

Furthermore it has proved to be particularly advantageous for signal and/or energy transmission systems, travel measuring systems, encoding systems or similar systems to be provided in the travel and/or guide profile that on the cab side can read in and out signals and/or data, travel measurement data and travel and shaft markings bidirectionally via pick-ups.

The energy can thus be supplied without wires to the cabin or to the at least one drive to move the cabin up and down in a linear manner.

In addition, arrester devices can be provided arranged preferably in the cabin floor area that are designed as centrifugal brakes or similar systems, said arrester devices being positively connected to the linear guide preferably via pinion elements in order to brake the cabin in the event of a fault. Such self-monitoring brake systems can also be linked, for example, to the drive element, in particular the drive pinion or even the drive proper. The invention is not limited to this, but preferably these should be independent and engage automatically and positively in the linear guide.

For installation it has proved advantageous that the travel and/or guide profile can be assembled, slid or slotted together in segments at the face ends with insertable or separable or replaceably inserted linear guide, while at the same time the corresponding signal and/or energy transmission systems, travel measuring systems, encoding systems can also be connected together at the face ends.

All that is needed to do this are segments of the travel and/or guide profiles of different lengths and linear guides in order to carry out a very quick and simple installation on site or also to ensure a replacement of, for example, worn linear guides. This should also lie within the scope of the present invention.

### BRIEF DESCRIPTION OF THE DRAWINGS

Further advantages, features and details of the invention can be gathered from the following description of preferred embodiments and from the drawing.

FIG. 1 shows a schematic side view of a self-propelled elevator;

FIG. 2 shows a schematic cross-section through a section of the travel and/or guide profile and of the fastening profile, and the connection of the travel and/or guide profile to the cabin with drive;

FIG. 3 shows a schematic perspective view of a possible linear guide with possible drive element.

### DETAILED DESCRIPTION

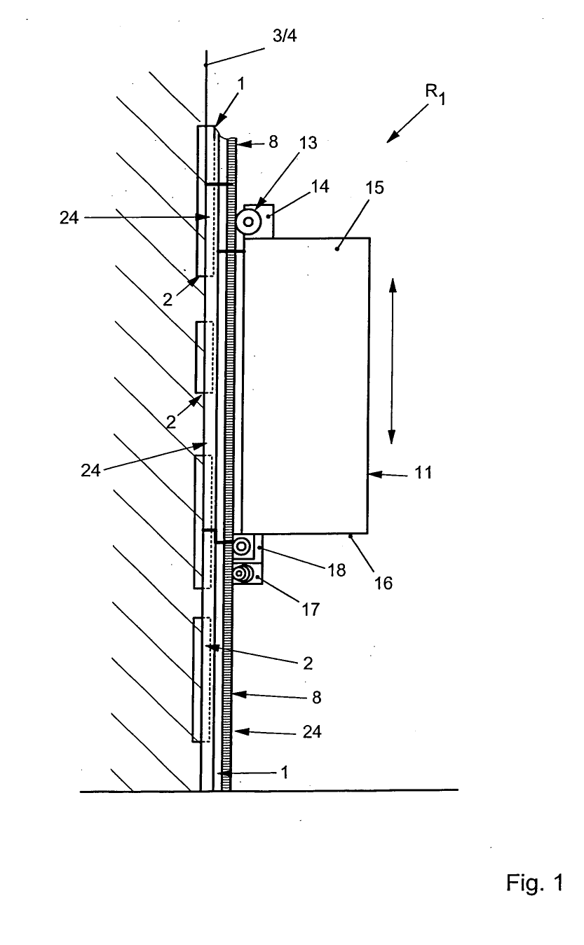

The schematic side view according to FIG. 1 shows only the main parts of the self-propelled elevator R₁.

There at least one travel and/or guide profile 1 is separably fixed to a construction 3, wall 4 or similar structure by means of individual fastening profiles 2.

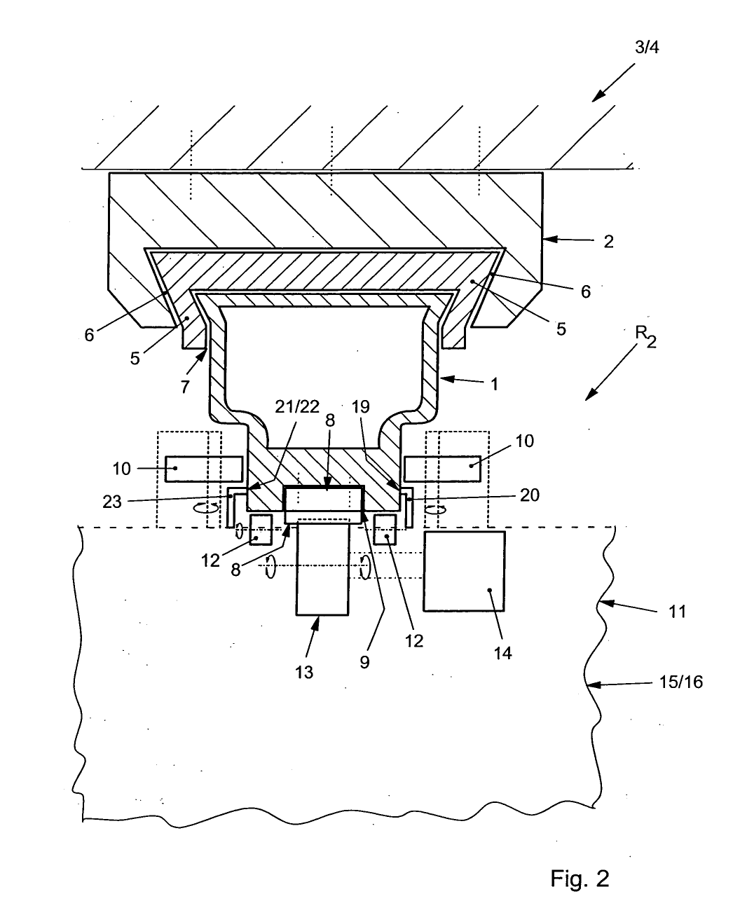

The individual fastening profiles 2 that have a preferably longitudinal form, but which may also have the form of a bracket, hold the travel and/or guide profile 1, preferably in a vibration-damping manner, as indicated in cross-section in FIG. 2.

A rubber buffer 5 is inserted between the fastening profile 2 and the travel and/or guide profile 1.

The fastening profile 2 preferably has a dovetail-shaped groove 6 in which the rubber buffer 5 fits exactly.

The travel and/or guide profile 1 is inserted into a recess 7 and vibration-damped in relation to fastening profile 2. The travel and/or guide profile 1 is designed as a hollow body in cross-section, but can also be designed as an open profile.

The fastening profiles 2 can be fixed separably to the construction 3 and/or wall 4.

A further feature of the present invention is that the travel and/or guide profile 1 holds a linear guide 8 separably in a mounting 9 of the travel and/or guide profile 1, said linear guide 8 being preferably designed as a profiled section, in particular a rack.

The linear guide 8 can preferably be inserted separably and replaceably in the mounting 9 of the travel and/or guide profile 1.

In addition, lateral guide rollers 10 of a cabin 11 can be provided on each side in the conventional manner as merely indicated in FIG. 2 in order to bear the cabin 11 from the side against the travel and/or guide profile 1.

In addition, gauge rollers 12 are assigned to the cabin 11, as indicated in FIG. 2 that serve for the further guidance of the cabin 11 against the travel and guide profile 1.

A special feature of the present invention is furthermore that a drive element 13 linked directly or indirectly to a drive 14 is firmly attached to the cabin 11, preferably to a cabin roof 15 or cabin floor 16, with the drive element 13 preferably being positively engaged with the linear guide 8.

By a corresponding rotatory driving of the drive element 13 that is mounted opposite the cabin 11, the cabin 11 can be moved up and down in a linear manner relative to the travel and/or guide profile 2.

The scope of the present invention should include that at least one drive element 13 and at least one drive 14 are assigned to the cabin 11 in the area of the cabin roof 15 and/or in the area of the cabin floor 16.

If more travel and/or guide profiles 1 are provided, correspondingly more arrangements of travel and/or guide profiles 1 with drives 14 and drive elements 13 (not illustrated here) can be provided in the area of the cabin roof 15 and/or cabin floor 16. The invention is not limited to this.

Preferred, however, is a positive engagement of the drive element 13 in the linear guide 8 that here preferably has the form of a rack.

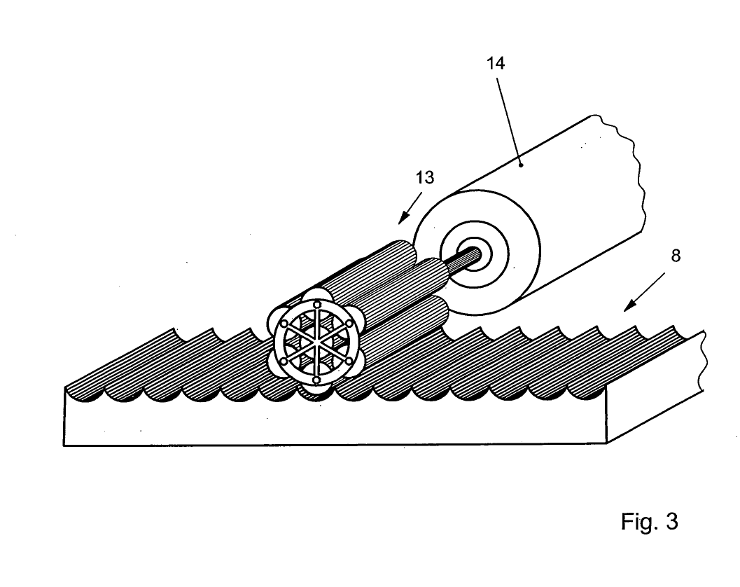

As shown by way of an example in FIG. 3, the linear guide 8 can have the form of a rack with corresponding troughs in which the drive element 13 engages with corresponding rolls like a drive pinion in order to move the cabin 11 in relation to the travel and/or guide profile 1 in a linear manner, precisely, noiselessly and with a minimum of energy.

In order to operate the self-propelled elevator R₁, R₂, or as illustrated in FIG. 2 in an energy-saving manner, at least one electricity recovery unit 17 can be assigned to the cabin 11 whose pinion (not illustrated here) is preferably in positive engagement with the linear guide 8.

Furthermore, at least one arrester device 18 with corresponding pinions (not illustrated here) engaging in the linear guide 8 is preferably provided in the area of the cabin floor 16 in order to brake the cabin 11 if a certain speed and/or acceleration is exceeded.

With the present invention, the self-propelled elevator R₁, R₂ can be designed with or without counterweight, with a corresponding supply of energy to the at least one drive 14 and a corresponding control of the self-propelled elevator R₁, R₂ being simplified. With the present invention it has proved advantageous for a signal and/or energy transmission system 19 to be provided preferably at the side over the full length of the travel and/or guide profile 1 preferably between guide roller 10 and face-end gauge roller 12, in order to transmit energy and/or data to the cabin 11, also bidirectionally, via at least one pick-up 20 arranged on the cabin.

In addition, a travel measuring system 21 and/or encoding system 22 can be assigned to the travel and/or guide profile 1. The travel measuring system 21 and/or encoding system 22 is preferably located laterally in the travel and/or guide profile 1 over the full length between guide roller 10 and gauge roller 12 and can receive relevant information for shaft copying, positions, etc. via one or more pick-ups 23 arranged on the cabin.

The signal and/or energy transmission systems 19 as well as travel measuring system 21 and encoding system 22 are preferably set into the travel and/or guide profile 1 in the vicinity of the linear guide 8 so that information, energy and data can be transmitted bidirectionally from the traveling cabin 11 to the building, and energy can be supplied to the drives 14 of the cabin 11 and also to the control system of the cabin 11 without the use of wires.

The present self-propelled elevator R₁, R₂ could operate without shaft cables, etc.

Furthermore it has proved advantageous with the present invention, as indicated in FIG. 1, that the travel and/or guide profile 1, fastening profile 2 and the linear guide 8 as well as the signal and/or energy transmission system 19, travel measuring system 21 and encoding system 22 set into the travel and/or guide profile 1 to be divided into segments 24 that can be joined at their ends by inserting, sliding or slotting together.

In this way travel and/or guide profiles 1 and linear guide 8 of practically any length can be produced that not only simplify the installation, but also permit manufacturing in standard profiles.

As a result manufacturing costs can be significantly reduced, so that in addition to maintenance purposes, a replacement of linear guides 8 and travel and/or guide profile 1 is also possible subsequently at any time and at any point, even in the shaft.

It also ensured that conventional elevators can be easily retrofitted with or converted to such a system. This should also lie within the scope of the present invention.

1. Self-propelled elevator for essentially the transport of persons with a cabin (11) to which at least one drive (14) is assigned, wherein the at least one drive (14) is engaged directly or indirectly via at least one drive element (13) with a linear guide (8) for linear driving of the cabin (11).

2. Self-propelled elevator for essentially the transport of persons with a cabin (11) to which at least one drive (14) is assigned, wherein one linear guide (8) is connected to a travel and/or guide profile (1), in particular is integrated into a travel and/or guide profile (1).

3. Self-propelled elevator for essentially the transport of persons with a cabin (11) to which at least one drive (14) is assigned, wherein a linear guide (8) integrated into a travel and/or guide profile (1) is mounted vibration-damped in relation to at least one fastening profile (2) to hold the travel and/or guide profile (1).

4. Self-propelled elevator according to at least one of claims 1 to 3, wherein the drive element (13) is engaged positively with the linear guide (8).

5. Self-propelled elevator according to claim 4, wherein the drive element (13) is formed as a drive pinion that engages positively with a correspondingly formed linear guide (8), with the drive element (13) being connected to the drive (14) and both being firmly connected to the cabin (11).

6. Self-propelled elevator according to claim 5, wherein the travel and/or guide profile (1) and/or the linear guide (8) is formed in several parts and can be fitted together precisely at their ends.

7. Self-propelled elevator according to claim 6, wherein the at least one linear guide (8) is separably set into a mounting groove of the travel and/or guide profile (1).

8. Self-propelled elevator according to claim 7, wherein the linear guide (8) is formed as a rack profile.

9. Self-propelled elevator according to claim 8, wherein at least one vibration damping rubber buffer (5) is provided for vibration damping between travel and/or guide profile (1) and at least one fastening profile (2).

10. Self-propelled elevator according to claim 1, wherein via a plurality of individual mutually spaced fastening profiles (2) each with a rubber buffer (5), the travel and/or guide profile (1) with inserted linear guide (8) is mounted in a vibration-damped manner and via the fastening profile (2), the travel and/or guide profile (1) with inserted linear guide (8) can be fixed to a construction (3), a wall (4) or similar structure.

11. Self-propelled elevator according to claim 10, wherein at least one arrester device (18) is assigned to the cabin (11) that is engaged with the linear guide (8) and/or with the travel and/or guide profile (1).

12. Self-propelled elevator according to claim 11, wherein the at least one arrester device (18) is positively engaged with the linear guide (8).

13. Self-propelled elevator according to claim 12, wherein the at least one arrester device (18) is assigned to the drive element (13) and/or the drive (14), or is connected to the latter.

14. Self-propelled elevator according to claim 13, wherein at least one travel measuring system (21) is assigned to the travel and/or guide profile (1) and/or the linear guide (8).

15. Self-propelled elevator according to claim 14, wherein a signal and/or energy transmission system (19) is assigned to the travel and/or guide profile (1) and/or the linear guide (8), via which energy and/or data can be transmitted bidirectionally to the cabin (11) and the drive element (13).

16. Self-propelled elevator according to claim 15, wherein energy and/or data can be transmitted bidirectionally to the cabin (11) and/or the drive (14) via pick-ups (20, 23) correspondingly arranged on the cabin (11).

17. Self-propelled elevator according to claim 16, wherein at least one electricity recovery unit (17) is assigned to the drive (14) of the cabin (11).

18. Self-propelled elevator according to claim 17, wherein the travel and/or guide profiles (1) with integrated linear guide (8) can be assembled individually or together in segments (24), and that travel measuring systems (21) and signal and/or energy transmission systems (19) can also be slotted or connected together at their ends for simplified quick assembly.

19. Self-propelled elevator according to claim 18, wherein at least one encoding system (22) for travel or shaft marking is assigned to the travel and/or guide profile (1) and/or the linear guide (8), the signals from which being readable via corresponding pick-ups (20, 23) mounted on the cabin.
